(19) United States
(12) Patent Application Publication
(10) Pub. No.: US 2021/0403670 A1
(43) Pub. Date: Dec. 30, 2021

(54) METHOD FOR RECYCLING POLYESTER/POLYURETHANE

(71) Applicant: ZHEJIANG UNIVERSITY, Zhejiang (CN)

(72) Inventors: Tao XIE, Zhejiang (CN); Ning ZHENG, Zhejiang (CN); Haijun FENG, Zhejiang (CN); Qian ZHAO, Zhejiang (CN)

(73) Assignee: ZHEJIANG UNIVERSITY, Zhejiang (CN)

(21) Appl. No.: 17/199,385

(22) Filed: Mar. 11, 2021

(30) Foreign Application Priority Data
Jun. 24, 2020 (CN) 202010588840.X

(51) Int. Cl. C08J 11/24; C08J 11/16

(52) U.S. Cl. CPC C08J 11/24; C08J 2367/02; C08J 11/16

(57) ABSTRACT

A method for recycling polyester/polyurethane is provided. The method comprises adding additives containing hydroxyl or/and amino groups to polyester/polyurethane waste and performing transesterification or transcarbamoylation at 80-180° C. to form recycled new materials with different structures including polyester, polyurethane, polyamide, and polyurea.

### CROSS-REFERENCE TO RELATED APPLICATION

This application claims the priority benefit of China application serial no. 202010588840.X, filed on Jun. 24, 2020. The entirety of the above-mentioned patent application is hereby incorporated by reference herein and made a part of this specification.

### TECHNICAL FIELD

The present invention relates to the field of reproducing and reprocessing of polyester/polyurethane, and particularly relates to the method of recycling thermoset or thermoplastic polyester/polyurethane wastes.

### DESCRIPTION OF RELATED ART

Polyesters/polyurethanes are widely used in textiles, furniture, automobiles, construction equipment, and other fields. With the large production of these polymers, the recycling of polyester/polyurethane wastes has become the main focus of sustainable societal development. Polyesters/polyurethanes can be divided into thermoplastics and thermosets. The most widely used method for recycling thermoplastic polyester/polyurethane is reprocessing, which usually takes place at high temperatures (e.g. above the flow temperature of the material). During reprocessing, the materials will inevitably degrade, oxidize, and hydrolyze that resulting in performance reduction. Due to permanent chemical cross-linking nature, thermosets cannot be dissolved or melted, thus making it difficult to be reprocessed. For the above two reasons, the recycling of polymer wastes has become very difficult. Many studies have been reported to recycle polyesters/polyurethanes. A common method that is suitable for both thermosets and thermoplastics is the chemical decomposition that can revert materials back to monomers or oligomers (U.S. Pat. Nos. 5,635,584, 4,025,559, 3,983,087, etc.). Chemical decomposition includes hydrolysis, ammonolysis, alcoholysis, etc. Such methods achieve recycling by using heat steams of polyols or ammonia to dissociate ester bonds or urethane bonds. After separation and purification, the recycled monomers or oligomers can be reused as raw materials. However, this method has low recycling efficiency, high cost, high energy consumption, and long reaction time, which severely restricts its application in industry. Another type of recycling method is to reuse the wastes directly after grinding and adding additional adhesives. Although the cost of this method is particularly low, the performances of recycled polymers are quite limited, which will severely constrain their applications.

Another representative method for polyester/polyurethane thermosets recycling is realized by dynamic covalent bonds. Dynamic covalent bonds are a class of chemical bonds that can undergo reversible exchange under certain conditions. After the bond exchange, polymer wastes can be reprocessed to realize recycling. The ester bond and urethane bond in polyester/polyurethane are both dynamic covalent bonds, which can go through transesterification/transcarbamoylation. By using transesterification with a catalyst under heating conditions, Leibler et al. achieved reprocessing of ester bond-containing thermoset epoxy resin (U.S. Pat. No. 9,266,292 B2). The paper Reprocessing Postconsumer Polyurethane Foam Using Carbamate Exchange Catalysis and Twin-Screw Extrusion reported that the use of dibutyltin dilaurate to catalyze transcarbamoylation can achieve the reprocessing of thermoset polyurethane foam. Ideally, the recycled thermoset materials can maintain the original structure and performance. However, degradation during reprocessing is inevitable due to a large amount of catalysts and the high temperature needed for activation of dynamic bonds, which will lead to performance reduction.

### SUMMARY

The present invention provides a method for recycling polyester/polyurethane. The structure and composition of recycled materials are very different from their original counterparts. Their mechanical and thermodynamic properties are superior to the original materials.

The technical solution of the present invention is as follows.

A method for recycling polyester/polyurethane includes: adding additives containing hydroxyl or/and amino groups to polyester/polyurethane waste. After performing transesterification or transcarbamoylation at 80-180° C., recycled new materials with different structures, including polyester, polyurethane, polyamide, and polyurea, can be formed.

It should be pointed out that, the structure and composition between the recycled new materials and the original materials are very different. The performance of the recycled new materials depends not only on the performance of the original materials and the additives but also on the newly formed chemical bonds. The mechanical properties and thermodynamic properties of the recycled new materials are superior to the original ones. Specifically, these properties refer to strain at break, modulus, strength, toughness and thermal stability, etc.

The transesterification is shown in Reaction Formula I. By adding hydroxyl-containing additives, new polyester materials can be formed after transesterification. Additionally, adding amino-containing additives can form amide-based materials after transesterification. The transesterification temperature is 80-180° C.

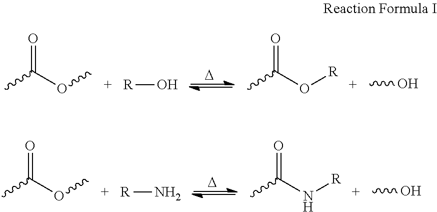

The transcarbamoylation reaction is shown in Reaction Formula II. By adding hydroxyl group-containing additives, new polyurethane materials can be formed after transcarbamoylation. Additionally, amino-containing additives can be used to form polyurea materials after transcarbamoylation. The transcarbamoylation temperature is 80-180° C.

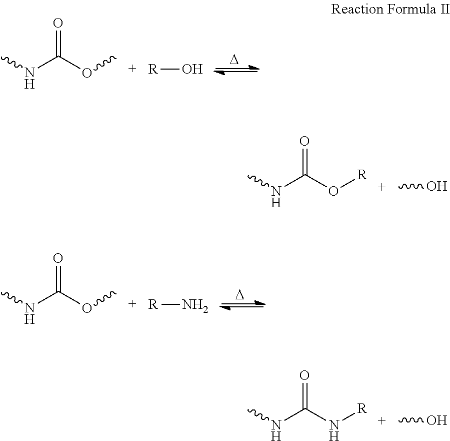

In the recycling method provided by this invention, ester/urethane bond in original polymers (polyester/polyurethane) will be partly or entirely broken, and additive is connected to the molecular chain of original polymers, results in excess hydroxyl groups suspended in polymer chains. In this situation, the recycled new materials have a lower crosslinking density, which results in a lower modulus and a higher strain at break. When amino-containing additives are added into the system, the ester/urethane bonds in the system are converted into amide/urea bonds. Compared with the original bond, the newly formed chemical bonds have higher bond energy and can generate more hydrogen bonding, so the toughness of the recycled new materials will increase. When additives possess certain mechanical properties (e.g. cellulose), the modulus/strength of the recycled polymers will increase after the additives are connected to the networks.

In the present invention, the polyester/polyurethane waste is thermoset or thermoplastic waste. Specifically, it includes but is not limited to, foam, fiber, elastomer, paint, adhesive, composite material, etc. The molding technique used during recovery is selected from hot pressing, screw extrusion, open kneading, dense kneading, etc. The molding temperature is the same as the transesterification/transcarbamoylation temperature.

Preferably, the polyester waste includes, but is not limited to, unsaturated polyester, saturated polyester, and other polymers with ester bonds. Polyurethane waste includes, but is not limited to, aliphatic polyurethane, aromatic polyurethane, and other polymers with urethane bonds.

Preferably, the amount of the additives is 1 wt %-50 wt % of polyester/polyamide waste.

Preferably, the hydroxyl-containing additives are selected from one or more of small molecules, synthetic polymers, and natural polymers, etc.

More preferably, the hydroxyl-containing small molecules include, but are not limited to, ethylene glycol, glycerin, butanediol, pentaerythritol, 3,5-dihydroxybenzyl alcohol, 3-amino-1,2-propanediol, diethyl diol, etc.

More preferably, the hydroxyl-containing synthetic polymers include, but are not limited to, polyvinyl alcohol, polytetrahydrofurandiol, polycaprolactonediol, polyethylene glycol, polypropylene glycol, polyethylene terephthalate, polybutylene terephthalate, polycarbonate, polylactic acid, polybutylene succinate, etc. Amongst, the structural formulas of polyvinyl alcohol, polytetrahydrofurandiol, polycaprolactone diol, polyethylene glycol, polybutylene succinate, and polybutylene terephthalate are as follows:

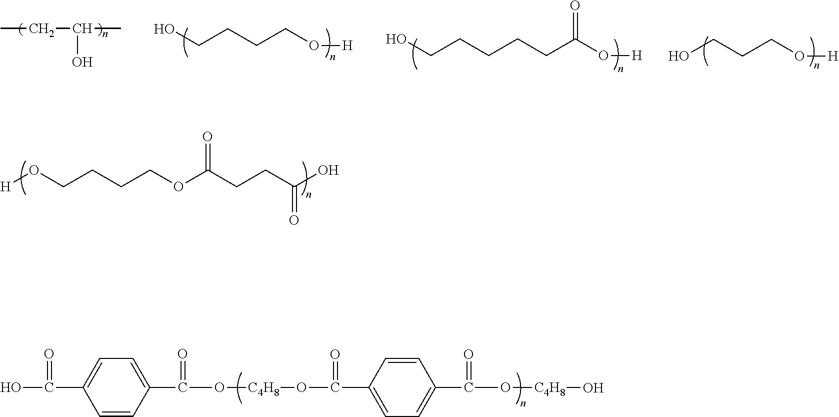

More preferably, the hydroxyl-containing natural polymers include, but are not limited to, starch, cellulose, glycogen, pentose, galactose, chitosan, chitin, alginic acid, etc. Amongst, the structural formulas of chitosan, chitin, cellulose, and alginic acid are as follows:

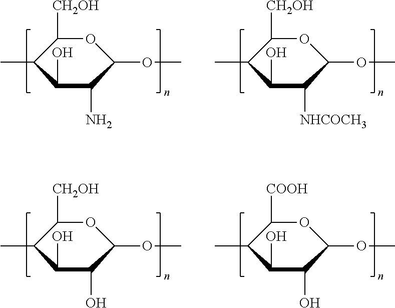

Preferably, the amino group-containing additives are selected from one or more of the small molecules or polymers.

More preferably, the amino-containing small molecule monomers include, but are not limited to, aniline, amylamine, furfurylamine, 3-butoxypropylamine, n-hexylamine, octadecylamine, p-phenylenediamine, ethylenediamine, 1,6-Hexanediamine, hexamethylenediamine, p-aminobenzylamine, 1,3-cyclohexanedimethylamine, N,N-bis(2-aminoethyl)-1,2-ethylene diamine, 2,2′,2″-triaminotriethylamine, N,N,N,N-tetrakis(3-aminopropyl)-1,4-butanediamine, etc.

More preferably, the amino group-containing polymers include, but are not limited to, polyaniline, branched polyethyleneimine, polyetheramine, polyoxyethylenediamine, etc. The structural formulas of polyaniline, polyoxyethylenediamine, tripolyetheramine, and branched polyamine ethyleneimine are as follows:

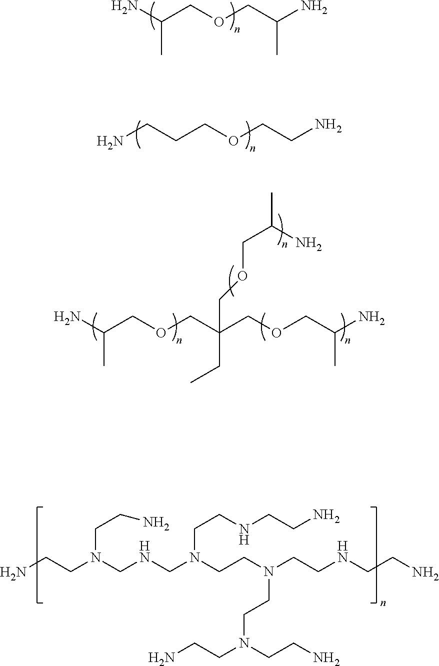

Preferably, the amount of the bond exchange catalyst is 0.01 wt of the polyester/polyurethane waste when such catalyst is added to polymer waste.

More preferably, the catalysts include, but are not limited to, one or more of triethylamine, 1,5,7-triazabicyclo[4.4.0]dec-5-ene, 1,8-diazabicycloundec-7-ene, benzenesulfonic acid, (4-methylphenyl)diphenylsulfonium trifluoromethanesulfonic acid, tin salt, zinc salt, calcium salt, magnesium salt, cobalt salt, etc.

It should be pointed out that, in order to further improve the performance of recycled new materials, additional new additives can be added during or after the reprocessing to further react with the free hydroxyl/amino groups in the materials. Preferably, the additional additives that can continue to react with hydroxyl/amino groups include, but are not limited to, isocyanate, isothiocyanate, epoxy, acid anhydride, carboxylic acid, aldehyde, etc.

In the present invention, after adding additives containing hydroxyl/amino groups to polyester/polyurethane waste, and through reversible exchange reaction between ester/urethane bonds and added additives, new polymer materials are formed after recycling. This type of recycled new material is very different from the original polyester/polyurethane in structure and composition. Its mechanical properties and thermodynamic properties are superior to the original materials and can be used in new fields.

Compared with existing technics, the benefits of the invention are:

(1) The performance of recycled new materials is better than the original materials. The recycled materials can be used directly and can be applied in new fields;

(2) The present invention is applicable to many polyester/polyurethane wastes. This invention with a wide variety of additives and diversified properties suitable for different applications, and with relatively low requirements of equipment, is expected to be used in industrial production.

### BRIEF DESCRIPTION OF THE DRAWINGS

FIG. 1 is the DSC curve of the materials in Example 1 before and after reprocessing with hydroxyl groups.

FIG. 2 is the stress-strain curve of Example 2 before and after polyurethane reprocessing with amino groups.

### DETAILED DESCRIPTION

The present invention will be further described in detail with the examples below. It should be noted that the examples described below are intended to help understand the details of this invention. And the method should not be limited to these examples.

In the following examples, DSC was used to measure the glass transition, melting transition, and crystallinity before and after recycling. DMA was used to characterize the thermodynamic properties of materials, and a universal material testing machine was used to measure the mechanical properties before and after recycling.

### Example 1 (Using Hydroxyl-Containing Polymers to Recycle Polyurethane)

Raw Material:

a) Hexamethylene diisocyanate (HDI), J&K Scientific Co., Ltd.;

b) Polycaprolactone diol (PCL): Mw=2000, Sigma-Aldrich Co., Ltd.;

c) Glycerin, Tokyo Chemical Industry Co., Ltd.;

d) Dibutyltin dilaurate (DBTDL), J&K Scientific Co., Ltd.;

e) Polybutylene glycol (PPG), J&K Scientific Co., Ltd.;

Preparation of Polyurethane:

Samples were weighed according to the ratio of PCL, glycerin, and HDI is 1:0.2:1.3 (molar ratio, wherein the molar ratio of the total hydroxyl number of PCL and glycerol to the isocyanate group was 1:1). After stirring properly, 0.1 wt % of DBTDL was added, and the mixed solution was poured into a mold. The mixture was reacted at 70° C. for 3 h.

Polyurethane Recycling:

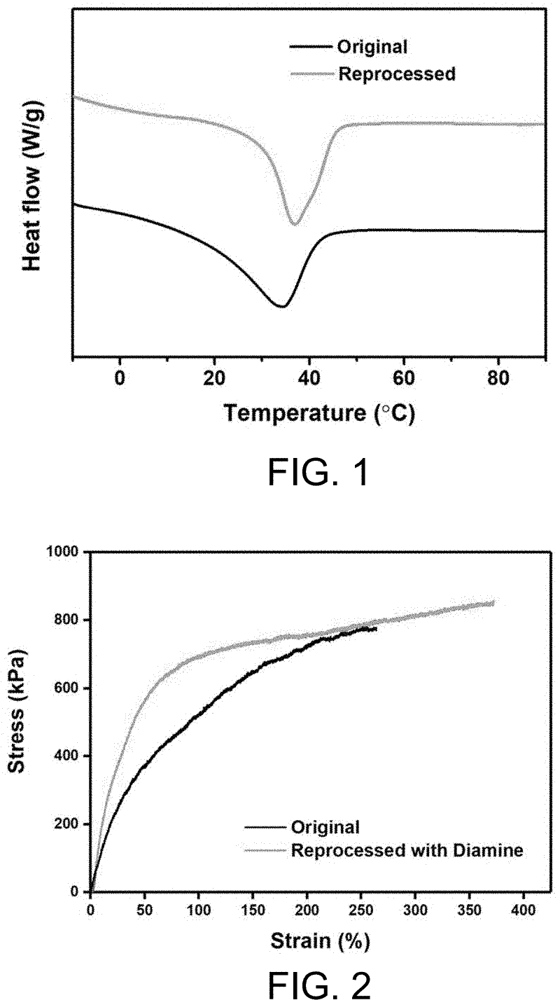

10 g of polyurethane was weighed and ground into powder in a ball mill machine. Subsequently, 1 g of PPG was added to the polyurethane powder. After mixing properly, the mixture was conducted at 120° C. for 2 hours in a mold. Finally, a new polyurethane was formed. The melting temperature of the recycled sample is 3° C., which higher than the original sample, as shown in FIG. 1.

### Example 2 (Using Amino-Containing Polymers to Recycle Polyurethane)

Raw Material:

a) Diphenylmethane diisocyanate (MDI), J&K Scientific Co., Ltd.;

b) Polytetrahydrofurandiol (PTMG): Mw=1000, Sigma-Aldrich China;

c) Glycerin, Tokyo Chemical Industry Co., Ltd.; l

d) Polyetheramine (D230), J&K Scientific Co., Ltd.;

Preparation of Polyurethane:

The samples were weighed according to the ratio of PTMG, glycerin, and MDI of 1:0.2:1.3 (molar ratio, wherein the molar ratio of the total hydroxyl groups of PPG and glycerol to the isocyanate group was 1:1). After stirring properly, the mixed solution was poured into a mold and reacted for 3 hours under heating at 70° C.

Polyurethane Recycling:

10 g of polyurethane was weighed and ground into powder in a ball mill machine. Subsequently, 1 g of D230 was added to the polyurethane powder and mixed properly. The mixture was conducted at 120° C. for 2 hours in a mold. Finally, a new polyurethane-polyurea was formed. The modulus of the recycled sample is 0.8 MPa, which is higher than the original sample. And the strain at break is 100% higher than the original sample, as shown in FIG. 2.

### Example 3 (Adding Additives Twice to Recycle Polyurethane)

Raw Material:

a) Diphenylmethane diisocyanate (MDI), J&K Scientific Co., Ltd.;

b) Polytetrahydrofurandiol (PTMG): Mw=1000, Sigma-Aldrich Co., Ltd.;

c) Glycerin, Tokyo Chemical Industry Co., Ltd.;

d) Polyetheramine (D230), J&K Scientific Co., Ltd.;

Preparation of Polyurethane:

The samples were weighed according to the ratio of PTMG, glycerin, and MDI of 1:0.2:1.3 (molar ratio, wherein the molar ratio of the total hydroxyl groups of PPG and glycerol to the isocyanate group was 1:1). After stirring properly, the mixed solution was poured into a mold and reacted for 3 hours at 70° C.

Polyurethane Recycling:

10 g of polyurethane was weighed and ground into powder in a ball mill machine. Then 1 g of D230 was added to the polyurethane powder and mixed well. After stirring evenly in a screw extruder at 120° C., 0.5 g of MDI was added. The mixture was molded at 120° C. for 2 h to obtain a new polyurethane-polyurea material. The modulus of the recovered sample is 1 MPa higher than the original sample, and the strength is 0.5 MPa higher than the original sample.

### Example 4 (Recycling Polyester Using Small Molecules Containing Hydroxyl and Amino Groups)

Raw Material:

a) Dimethyl terephthalate, J&K Scientific Co., Ltd.;

b) 1,4-Butanediol, J&K Scientific Co., Ltd.;

c) Glycerin, Tokyo Chemical Industry Co., Ltd.;

d) N,N′-diisopropylcarbodiimide, J&K Scientific Co., Ltd.;

e) Pentaerythritol, J&K Scientific Co., Ltd.;

f) Aniline, J&K Scientific Co., Ltd.;

Preparation of Polyester:

The sample was weighted according to the molar ratio of dimethyl terephthalate, 1,4-butanediol and glycerol are 1.3:1:0.2 (molar ratio, wherein the molar ratio of the carboxyl groups of dimethyl terephthalate 1,4-butanediol, glycerol, and the total hydroxyl group of alcohol is 1:1). After stirring properly, 0.05 wt % of N,N′-diisopropylcarbodiimide was added, and the mixed solution was poured into a mold and reacted under vacuum at 120° C. for 8 hours.

Polyester Recycling:

10 g of polyester was weighed and ground into powder in a ball mill machine. Subsequently, 0.5 g of pentaerythritol and aniline were added to the polyester powder. After mixing, the mixture was conducted at 120° C. for 5 hours in a mold. Finally, a new polyester material was obtained. The strain at break of the recycled sample is 5% higher than the original sample.

### Example 5 (Recycling Polyester Using Hydroxyl/Amino-Containing Natural Polymer Filler)

Raw Material:

a) Dimethyl terephthalate, J&K Scientific Co., Ltd.;

b) 1,4-Butanediol, J&K Scientific Co., Ltd.;

c) Glycerin, Tokyo Chemical Industry Co., Ltd.;

d) N,N′-diisopropylcarbodiimide, J&K Scientific Co., Ltd.;

e) Hydroxyethyl cellulose, J&K Scientific Co., Ltd.;

Preparation of Polyester:

The sample was weighted according to the ratio of dimethyl terephthalate, 1,4-butanediol and glycerol are 1.3:1:0.2 (molar ratio, wherein the carboxyl group of dimethyl terephthalate, 1,4-butanediol, glycerol, and the hydroxyl group of alcohol is 1:1). After stirring properly, 0.05 wt % of N,N′-diisopropylcarbodiimide was added, and the mixed solution was poured into a mold and reacted under vacuum at 120° C. for 8 hours.

Polyester Recycling:

10 g of polyester was weighed and ground into powder in a ball mill machine. Subsequently, 1 g of hydroxyethyl cellulose powder was added to the polyester powder. After mixing, the mixture was conducted at 120° C. for 3 hours in a mold. Finally, a new polyester was obtained. The modulus of the recovered sample is 10 MPa higher than the original sample, and the strength is 5 MPa higher than the original sample.

### Example 6 (Recycling of Polyurethane Foam)

Raw Material:

a) Polyurethane foam insulation board, Shenzhen Lvjianbao Material Co., Ltd.;

b) Tripolyetheramine, J&K Scientific Co., Ltd.;

Recycling of Polyurethane Foam:

10 g of polyurethane foam was weighed and ground into powder in a ball mill machine. Subsequently, 1 g of polyether amine was added to the polyurethane powder and conducted at 130° C. for 5 hours in a mold to obtain a new polyurethane film material. The strain at break of the recovered sample is 50% higher than the original sample.

### Example 7 (Recycling of Polyester Fiber)

Raw Material:

a) Polyester fiber, Changzhou Zhuwei Building Material Co., Ltd.;

b) Polyetheramine (D230), J&K Scientific Co., Ltd.;

c) 1,5,7-triazabicyclo[4.4.0]dec-5-ene (TBD), Tokyo Chemical Industry Co., Ltd.;

Recycling of Polyester Fiber:

10 g of polyester fiber was weighed and ground into powder in a ball mill machine. Subsequently, 1 g of D230 and 0.1 wt % of TBD were added to the polyurethane powder and conducted at 120° C. for 3 hours in a mold to obtain a new polyester film. The strain at break of the recycled sample is 10% higher than the original sample.

### Example 8 (Recycling of Waste Buttons: Recycling of Ethylene and Styrene Copolymers)

Raw Material:

a) Buttons, Yongjia County Weizhi Button Co., Ltd.;

b) P-phenylenediamine, J&K Scientific Co., Ltd.;

c) 1,5,7-triazabicyclo[4.4.0]dec-5-ene (TBD), Tokyo Chemical Industry Co., Ltd

Recycling of Discarded Buttons:

10 g of buttons were weighed and ground into powder in a ball mill machine. Subsequently, 1 g of p-phenylenediamine and 0.1 wt % of TBD were added to the polyurethane powder, mixed in a twin-screw extruder at 150° C. for 3 hours, and then conducted for 3 hours in a mold to obtain a new polyester film. The strain at break of the recycled sample is 20% higher than the original sample.

What is claimed is:

1. A method for recycling polyester/polyurethane, comprising:
adding additives containing hydroxyl or/and amino groups to polyester/polyurethane waste; and
performing transesterification or transcarbamoylation at 80-180° C. to form recycled new materials with different structures, including polyester, polyurethane, polyamide, and polyurea.

2. The method of claim 1, wherein the polyester/polyurethane waste is thermoset or thermoplastic polymer.

3. The method of claim 1, wherein an amount of the additives is 1 wt %-50 wt % of the polyester/polyurethane waste.

4. The method of claim 1, wherein the hydroxyl-containing additives are selected from one or more of hydroxyl-containing small molecules, hydroxyl-containing synthetic polymers, and hydroxyl-containing natural polymers.

5. The method of claim 4, wherein the hydroxyl-containing small-molecules include one or more of ethylene glycol, glycerin, butanediol, pentaerythritol, 3,5-dihydroxybenzyl alcohol, 3-amino-1,2-propanediol, and diethylene glycol;
the hydroxyl-containing synthetic polymers include one or more of polyvinyl alcohol, polytetrahydrofurandiol, polycaprolactonediol, polyethylene glycol, polypropylene glycol, polyethylene terephthalate, polybutylene terephthalate, polycarbonate, polylactic acid, and polybutylene succinate; and
the hydroxyl-containing natural polymers include one or more of starch, cellulose, glycogen, pentose, galactose, chitosan, chitin, and alginic acid.

6. The method of claim 1, wherein the amino group-containing additives are selected from one or more of amino-containing small molecules and amino-containing polymers.

7. The method of claim 6, wherein the amino-containing small molecules include one or more of aniline, amylamine, furfurylamine, 3-butoxypropylamine, n-hexylamine, octaamine, p-phenylenediamine, ethylenediamine, 1,6-hexanediamine, hexamethylenediamine, p-aminobenzylamine, 1,3-cyclohexanedimethylamine, N,N-bis(2-(Aminoethyl)-1,2-ethylenediamine, 2,2′,2″-triaminotriethylamine, and N,N,N,N-tetrakis(3-aminopropyl)-1,4-butane; and
the amino-containing polymers include one or more of polyaniline, branched polyethyleneimine, polyetheramine, and polyoxyethylenediamine.

8. The method of claim 1, the method further comprising:
adding bond exchange catalysts to the polyester/polyurethane waste,
wherein an amount of the bond exchange catalysts is 0.01 wt %-10 wt % of the polyester/polyurethane waste.

9. The method of claim 2, the method further comprising:
adding bond exchange catalysts to the polyester/polyurethane waste,
wherein an amount of the bond exchange catalysts is 0.01 wt %-10 wt % of the polyester/polyurethane waste.

10. The method of claim 3, the method further comprising:
adding bond exchange catalysts to the polyester/polyurethane waste,
wherein an amount of the bond exchange catalysts is 0.01 wt %-10 wt % of the polyester/polyurethane waste.

11. The method of claim 4, the method further comprising:
adding bond exchange catalysts to the polyester/polyurethane waste,
wherein an amount of the bond exchange catalysts is 0.01 wt %-10 wt % of the polyester/polyurethane waste.

12. The method of claim 5, the method further comprising:
adding bond exchange catalysts to the polyester/polyurethane waste,
wherein an amount of the bond exchange catalysts is 0.01 wt %-10 wt % of the polyester/polyurethane waste.

13. The method of claim 6, the method further comprising:
adding bond exchange catalysts to the polyester/polyurethane waste,
wherein an amount of the bond exchange catalysts is 0.01 wt %-10 wt % of the polyester/polyurethane waste.

14. The method of claim 7, the method further comprising:
adding bond exchange catalysts to the polyester/polyurethane waste,
wherein an amount of the bond exchange catalysts is 0.01 wt %-10 wt % of the polyester/polyurethane waste.

15. The method of claim 8, wherein the bond exchange catalysts include one or more of triethylamine, 1,5,7-triazabicyclo[4.4.0]dec-5-ene, 1,8-diazabicycloundec-7-ene, benzenesulfonic acid, (4-methylphenyl)diphenylsulfonium trifluoromethanesulfonic acid, tin salt, zinc salt, calcium salt, magnesium salt, and cobalt salt.

16. The method of claim 1, the method further comprising:
adding additional additives to react with free hydroxyl or/and amino groups,
wherein the additional additives include one or more of isocyanate, isothiocyanate, epoxy, acid anhydride, carboxylic acid, and aldehyde.
